(19) United States
(12) Patent Application Publication
(10) Pub. No.: US 2002/0097729 A1
(43) Pub. Date: Jul. 25, 2002

(54) Processing messages in a gatekeeper of an internet protocol network

(75) Inventor: Sebastien Bouat, Crolles (FR)

Correspondence Address: HEWLETT-PACKARD COMPANY, Intellectual Property Administration, P.O. Box 272400, Fort Collins, CO, 80527-2400, US

(73) Assignee: Hewlett-Packard Company

(21) Appl. No.: 10/032,882

(22) Filed: Oct. 29, 2001

(30) Foreign Application Priority Data
Oct. 31, 2000 (EP) 00410132.5

(51) Int. Cl. G06F 15/16; H04L 12/28; H04L 12/56; H04M 7/00

(52) U.S. Cl. 370/401; 379/229

(57) ABSTRACT

The invention concerns a method for processing messages incoming on a gatekeeper system of an Internet Protocol network, characterized in that the method includes a plurality of sub-processes each able to process a series of such messages and the method includes the step of dispatching the messages incoming on the gatekeeper system onto those different sub-processes, the dispatching step including identifying whether a message belongs to a same call as a previous message, and, in that case, sending this message to the same sub-process as said previous message.

The invention deals with Internet Protocol networks (IP networks), and particularly with voice conferencing over such networks.

An international standard called H323 has been developed for conferencing over IP networks, which aims at allowing not only different Internet telephony products to inter-operate, but also to allow interoperability between ISDN (Integrated Service Digital Network) and telephony based conferencing systems.

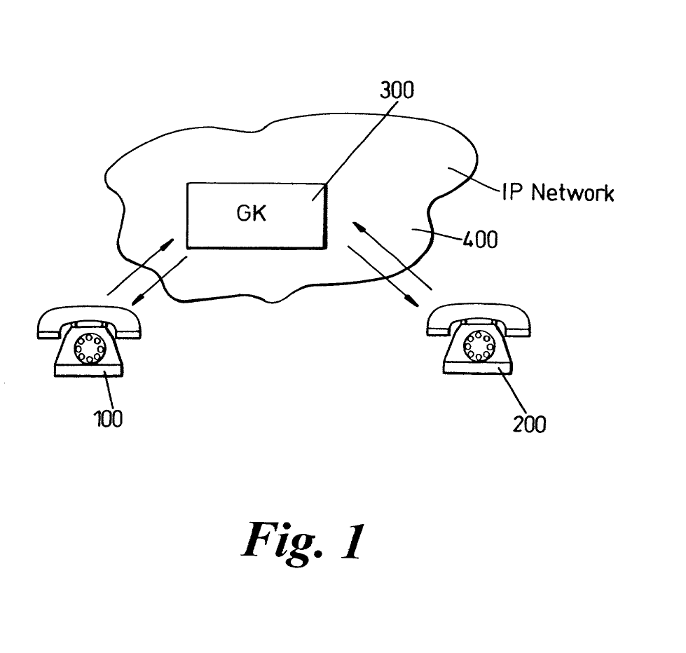

An elementary H323 configuration of a network comprises, as illustrated in FIG. 1, two end-points 100 and 200, such as two IP phones, and a gatekeeper 300. The gatekeeper 300 is usually a part of the Internet-protocol network, referenced 400 on the figure.

The gatekeeper 300 is the network infrastructure component which allows the two end-points 100 and 200 to establish a call. In a routed mode, when theend-point 100 requires the establishment of the call, it sends a first admission request to the gatekeeper 300. This request includes, for instance, a conference identifier that identifies uniquely the call and also includes identifiers of the caller and the callee.

The gatekeeper 300 checks that the call can be established between the caller 100 and the callee 200 (for example that the caller 100 still owns prepaid communication time rights, or that the callee is available at the moment). This checking is carried out on the basis of data contained in the message and on the basis of background data contained in the gatekeeper.

If the gatekeeper 300 authorises the call, it sends an admission confirmation message to the source end point 100 that has made the request. To set-up a call, a series of messages are sent between the caller and the gatekeeper, and between the gatekeeper and the callee. Both caller 100 and callee 200 send admission requests (set messages) to the gatekeeper 300. The admission requests contain the identifiers of the caller 100 and the callee. In response to each admission request the gatekeeper sends an admission confirm.

Admission messages belong to a message protocol called Registration, Admission and Status (RAS). Two other types of RAS messages involved in calls are RAS bandwidth requests and disengage requests. RAS bandwidth requests are sent when two end-points which are already in communication request a change in bandwidth, for example when a very large file is to be exchanged between them. When the call completes, disengage messages are exchanged.

Messages hold a set of information elements which enable the identification of the source, the destination endpoint and so on. One special information element is the conference identifier that identifies uniquely a call and is the same for all the messages that belong to that call. The conference identifier is a globally unique identifier generated using rules that ensure that it is unique. The previously mentioned messages are call-oriented and include a conference identifier.

As voice communication over IP networks is becoming a key mode of communication, the increasing voice IP traffic requires more and more performance on the part of the gatekeeper side. The invention proposes a method of processing messages in a gatekeeper system, which tends to improve the capacities of a gatekeeper system.

The invention also proposes a gatekeeper system with larger capacities, and a component able to improve the capacities of a gatekeeper system.

Another aim of the invention is to provide a processing method and a gatekeeper system, along with a component for a gatekeeper system, which allow easy extensive software or hardware modifications in a gatekeeper.

A method according to the invention is a method for processing messages incoming on a gatekeeper system of an Internet Protocol network, wherein the gatekeeper system includes a plurality of sub-processes each able to process a series of such messages, the method including the step of dispatching the messages incoming on the gatekeeper system onto the different sub-processes, the dispatching step including identifying whether a message belongs to a same call as a previous message, and, in that case, sending this message to the same sub-process as that to which the previous message was sent.

A gatekeeper system according to the invention is a gatekeeper system of an Internet Protocol network, the gatekeeper system hosting a plurality of sub-processes each able to process a series of messages, wherein the gatekeeper system is able to dispatch the messages onto those different sub-processes, and further wherein the gatekeeper system identifies whether a message belongs to the same call as a previous message, and, in that case, sending this message to the sub-process that processed the previous message.

A component according to the invention is a component for a gatekeeper system of an Internet Protocol Network, comprising means for dispatching messages incoming on that component onto a plurality of sub-processes, the component being able to identify whether a message belongs to the same call as a previous message, and, in that case, being able to send this message to the sub-process that processed said previous message.

Other features, aims and advantages of the invention will appear to those skilled in the art through the following description of preferred embodiments of the invention, and through the appended figures, among which:

FIG. 1 illustrates a simple IP signalling network, according to the state of the art;

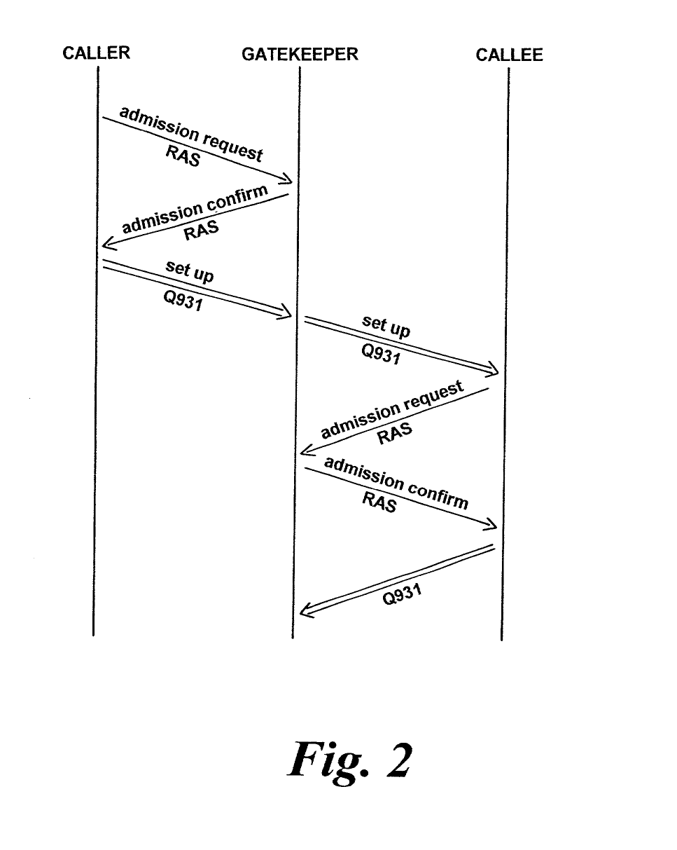

FIG. 2 is a diagram which illustrates exchanges of messages between a caller, a callee and a gatekeeper during a call set-up, according to the state of the art;

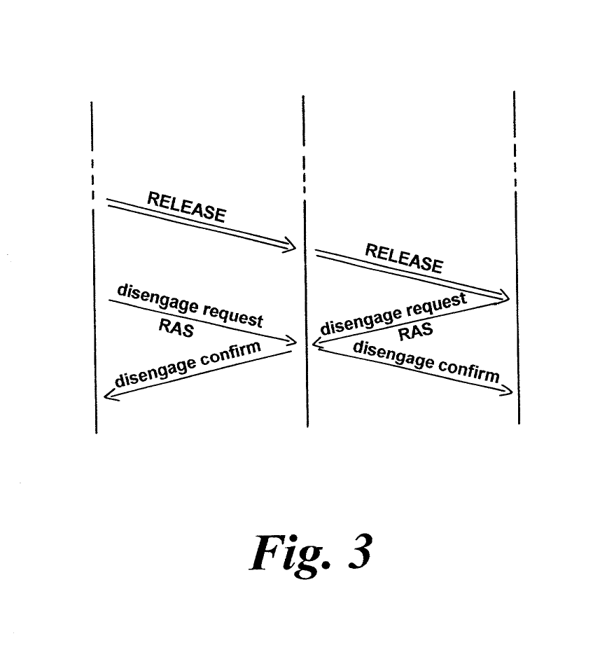

FIG. 3 is a diagram which illustrates exchanges of messages between a caller, a callee and a gatekeeper during a call disengagement, according to the state of the art;

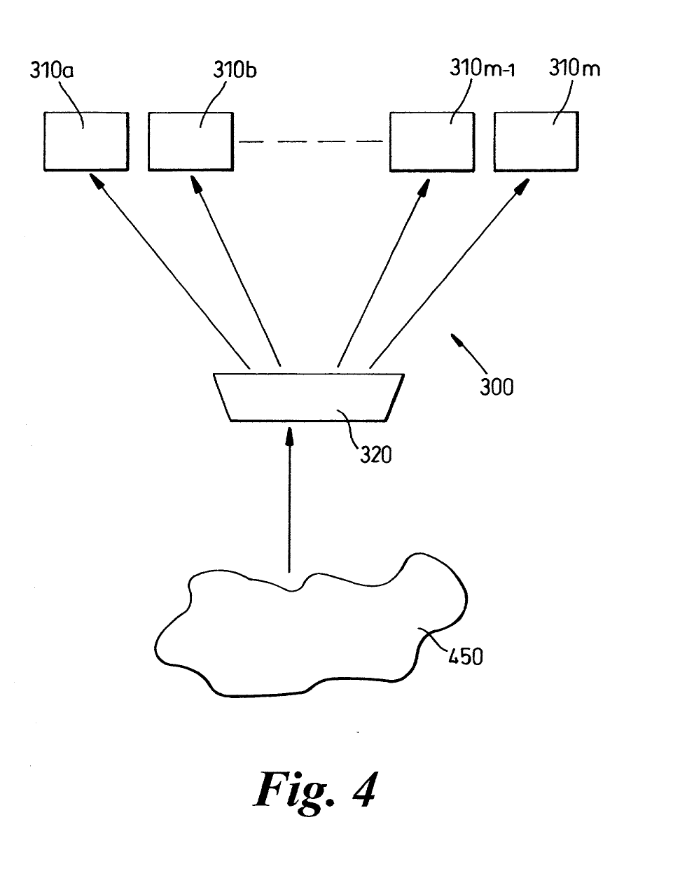

FIG. 4 represents a gatekeeper system according to an embodiment of the present invention.

Call set-up in H323 is ruled by two protocols; the Registration, Admission and status (RAS) protocol, and the Q931 protocol. FIG. 2 illustrates schematically the traditional RAS and Q931 messages sent between a caller, a gatekeeper and a callee during a call set-up. On this figure, each arrow represents a message and it is indicated on each arrow whether the message is a RAS or a Q931 message. In addition to the previously mentioned messages, a RAS message can also be a registration message which is sent when an IP end-point is first connected to the network, i.e. when the existence of a new end-point is declared to the gatekeeper.

As illustrated in FIG. 4, the present gatekeeper system 300 includes a series of gatekeeper instances 310a, 310b, . . . , 310n, which are each able to process different incoming messages. In one embodiment each instance 310a, 310b, . . . , 310n is a different sub-process carried out on a different processor. In other embodiments, each instance may be hosted by the same processor, or by a number of processors which is different from the number of sub-processes. Additionally, each instance may also belong to a single computer or to a farm of computers.

The gatekeeper 300 has such a scalable architecture which allows new instances to be added if the load on the gatekeeper 300 becomes too heavy.

The gatekeeper 300 is seen as a single gatekeeper from the rest of the network 450, and from other signalling services, for example from signaling services developed by users of a platform called “Open Call Multiservice Controller platform”, produced by HEWLETT PACKARD.

The gatekeeper 300 includes a module 320, hereinafter referred to as a demux module, which dispatches incoming messages to the set of gatekeeper instances 310a, 310b, . . . , 310n. In one embodiment the demux module 320 is a specific hardware unit with its own specific software. Alternatively, the demux module 320 can be a pure software element. The demux module 320 first determines whether a message is a registration or an admission message. If the message is a registration message, the demux module 320 sends the message to any of the gatekeeper instances 310a, 310b, . . . , 310n according to a load balancing policy. This load balancing policy can be any load balancing policy used in other computer systems. The load balancing policy can be unrelated to the rest of the dispatching algorithm. The load balancing policy is simply an enabler for load balancing for registrations and new calls.

If the message is the first one of a call, i.e. a RAS initial admission, the demux module 320 also sends it to any gatekeeper instance 310a, 310b, . . . , 310n according to the load balancing policy.

A RAS message typically includes a conference identifier (conference ID) which uniquely identify a call. The receiving instance 310a, 310b, . . . , 310n is then responsible for identifying itself as the gatekeeper instance to hold Q931 traffic.

If an incoming message belongs to a call for which at least one admission message has already been received by the demux module 320, the demux module 320 sends the message to the gatekeeper instance that received the previous message of the call. In other words, once an instance has received a first admission message of a call it then owns the call and receives all subsequent RAS messages of the call. This means that the Q931 address of the allocated gatekeeper instance 310a, 310b,. . . , 310n is given to the terminal that has sent the admission message so that the allocated gatekeeper instance 310a becomes the gatekeeper in the eyes of the terminal which has sent the message, and also in the eyes of the other terminals concerned by the call.

The H323 standard makes provision for a gatekeeper to give at admission-on-stage its Q931 address (or even possibly the Q931 address of the callee end-point if Q931 is direct).

In the same manner as a traditional gatekeeper in a routed mode, this allocated instance is responsible for holding the Q931 traffic of the call. In other words, this instance plays the role of a usual gatekeeper after it has identified itself as such. Dedicating the instances 310a, 310b, . . . , 310n to their own calls provides a better global efficiency. When an instance receives a new message from a a known call, the allocated instance already has the background information relating to the call. As mentioned previously, the conference ID is different from one call to another, even if two calls are made by the same caller.

As this method dispatches the messages on the basis of their conference ID, the messages are essentially dispatched on a call basis. This feature is very advantageous in the case of messages coming from a signalling gateway. A signalling gateway is the component that makes the interface between a H323 network and a Public Switched Telephone Network (PSTN). A gateway is a H323 end-point and hides a large number of PSTN calls to the H323 network.

In the case of messages which transit through a gateway, these messages are usually seen by a gatekeeper as coming from the same IP end-point, i.e. the gateway. The gatekeeper usually does not see the phones from which the messages come. In previous solutions, even if the dispatching method were to be based on an end-point analysis (or registration analysis) it would send all the messages coming from that gateway onto the same instance, which means that the instance would be rapidly overwhelmed.

Since the present dispatching method is carried out on a call basis (more precisely on a conference ID value) different messages coming from the same gateway are dispatched taking account of the actual calls to which messages belong to. As the main H323 workload is due to call processing, the present dispatching method is very efficient.

RAS messages are specified by ASN.1 standard and are encoded according to a model named PER (Packed Encoding Rules). ASN.1 standard specifies how to describe data structures in a non ambiguous manner. ASN1 structures are usually tree structures. ASN.1 allows any kind of data structure to be described. For example, a data structure may contain scalar types (integer, . . . ) bound or unbound arrays, alternatives, or other data structures. Fields within a data structure may also be optional.

The H323 message set (defined in H225 recommendation) is very complex and holds more than 60 thousands ‘leaves’. For instance, the whole definition of an admission message requires several pages.

Furthermore, the RAS message are notably created under ASN 1 standard, but are also encoded under the PER model. PER encoding reduces the size of the message to a minimum number of bits and, in particular, reduces the size of some fields to their effective length. For example, a number on several bytes may be reduced to a single byte according to its value. Furthermore, expressions are not byte aligned. If an expression can be encoded on a number of bits (eg. An integer lower than 32 will be encoded on 5 bits), the next expression will not start on a byte boundary but at the 6^{th} bits of the current byte.

The final PER encoded message is known as being very hard to understand especially as it has a sequence of fields of bits which have different sizes, each field being in turn a sequence of other fields, and so on.

Previously RAS messages required very complex software tools to be decode them. This is especially true for complex message sets where writing the codes by hand would be inaccurate. Previously, the software tools had to completely decode the PER message, which is time intensive.

This decoding is typically carried out in gatekeepers.

Herein, a lightweight decoding method is proposed which is carried out at the level of the demux 320 in order to read only the data which are necessary for the dispatching, i.e. the message type and the conference ID. This partial decoding relies on the fact that the ASN.1 structures have a tree structure and on the fact that the data of interest are not far from the first root fields of this tree structure. Since the indication of the message type is in one of the very first fields, the partial decoding process first reads the message type field. Then, depending on the message type, the process deduces the location of the conference ID field, if any.

For example, the demux deduces that the conference ID field is located after three fields which each represent character strings. To skip the fields before the conference ID, the demux module here needs to know all the fields that may precede the conference ID in the ASN.1 data structure.

The partial decoding method examines the fields appearing consequently in the tree structure and skips the fields which are not relevant. In the PER decoding the size of each field is either known a-priori, for fixed encoded-length fields, or, is indicated in the message for variable encoded-length fields. This is why it is possible for the partial decoding method to jump a field without having to read it.

The present lightweight-decoding algorithm runs in two steps. The first step consists in extracting the type of the RAS message. In a second step, if according to its type the message does belong to a call, the conference identifier is extracted.

Extracting the type only deals with the heading bits of the message. The head of RAS messages looks like:

bit n° 0: extension bit

bit n° 1 to bit n° 5: message type

bit n° 6 and after: payload

Message type is an integer value read from bits n° 1 to n° 5 of the message.

The location of the conference identifier (CID) fields depends on the message type and the actual contents of the message. Knowing the type of the message from the previous step, all message fields before CID are skipped. If a field is a scalar value, its length is known according to the PER standard: it is either a fixed length or it is read from the message. If a field is a data structure each field within this structure can be skipped in turn, and so on.

Consider, for example, an admission message (Admission Request or ARQ), wherein the message payload has the following structure: AdmissionRequest::=SEQUENCE

| | | |
|---|---|---|
| { | | |
| | requestSeqNum | RequestSeqNum, |
| | callType | CallType, |
| | callModel | CallModel OPTIONAL, |
| | endpointIdentifier | EndpointIdentifier, |
| | destinationInfo | SEQUENCE OF AliasAddress OPTIONAL, |
| | destCallSignalAddress | TransportAddress OPTIONAL, |
| | destExtraCallInfo | SEQUENCE OF AliasAddress OPTIONAL, |
| | srcInfo | SEQUENCE OF AliasAddress, |
| | srcCallSignalAddress | TransportAddress OPTIONAL, |
| | bandWidth | BandWidth, |
| | callReferenceValue | CallReferenceValue, |
| | nonStandardData | NonStandardParameter OPTIONAL, |
| | callServices | QseriesOptions OPTIONAL, |
| | conferenceID | ConferenceIdentifier, |
| | activeMC | BOOLEAN, |
| | answerCall | BOOLEAN, |
| | . . ., | |
| | canMapAlias | BOOLEAN, |
| | callIdentifier | CallIdentifier, |
| | srcAlternatives | SEQUENCE OF Endpoint OPTIONAL, |
| | destAlternatives | SEQUENCE OF Endpoint OPTIONAL, |
| | gatekeeperIdentifier | GatekeeperIdentifier OPTIONAL, |
| | tokens | SEQUENCE OF ClearToken OPTIONAL, |
| | cryptoTokens | SEQUENCE OF CryptoH323Token |
| | | OPTIONAL, |
| | integrityCheckValue | ICV OPTIONAL, |
| | transportQOS | TransportQOS OPTIONAL, |
| | willSupplyUUIEs | BOOLEAN |

}

An Admission Request (ARQ) message holds some possible extensions (it includes a “ . . . ” marker) and some optional fields. Since message extensions are located after the conference ID, it is possible to skip the heading extension bit in the PER representation. Since the message has some optional fields located before the CID, it is necessary to save the next 7 bits making an option presence mask.

The requestSeqNum field is a 16 bits integer. According to PER standard, it occupies 16 bits and is byte aligned. Accordingly, this field can be skipped.

The callType field is actually an extensible enumeration defined as: CallType ::=CHOICE

| | | |
|---|---|---|
| { | | |
| | pointToPoint | NULL, |
| | oneToN | NULL, |
| | nToOne | NULL, |
| | nToN | NULL, |
| | . . . | |
| } | | |

Depending on its extension bit, the value of call type attribute either belongs to one of four known types, or it is in the extension. In this case skip the extension bit and the 2 bits representing the value of the attribute can be skipped. For the latter case the extension bit and the actual extension according to the PER standard for choice extensions may be skipped.

The callModel field is optional and its presence can be identified in the option bit-mask at the start of message processing. If it is present it can be skipped according to its PER representation. In turn each field and possibly sub-fields of the message are skipped until the CID is reached. The CID can then be read from the the ARQ.

The present decoding method may scan several branches of the tree structure before arriving at the desired field. However, since we are interested in a few fields at the first levels of the hierarchy the CID value can be accessed very quickly by scanning only the highest level fields.

The present system includes a table that matches gatekeeper instances to conference ID's for all known calls.

As far as registration messages or first admission messages of a call are concerned, the load balancing policy used to dispatch those messages can be completely unrelated to the rest of the dispatching algorithm. It can also rely on a table which makes a correspondence between H323 call identifier and Gatekeeper instance, on tuples or on a hashing function over the H323 call identifier. Registration and admission are the most typical messages.

The method also applies to any RAS message the gatekeeper may receive. If a message is not call-related, it will be processed according to the registration message model. If a message belongs to a call, it will be processed according to the admission message model.

As far as RAS messages, such as RAS gatekeeper discovery or location requests, are concerned, they are sent to a dedicated gatekeeper instance called a “GK root”.

The present method is compatible with all H323 end-points, and all types of terminals. The terminals which exchange messages when the call is established can be for example IP phones, usual telephones, for example through a gateway, videoconference terminals or Personal Computers.

It should be understood that the IP network can be any IP network, local or not, such as the internet or an intranet network.

1. A method for processing messages incoming on a gatekeeper system of an Internet Protocol network, wherein the gatekeeper system includes a plurality of sub-processes each able to process a series of such messages, the method including the step of dispatching the messages incoming on the gatekeeper system onto the different sub-processes, the dispatching step including identifying whether a message belongs to a same call as a previous message, and, in that case, sending the message to the same sub-process as that to which the previous message was sent.

2. The method of claim 1, wherein the step of identifying whether a message belongs to a same call as a previous message includes the step of identifying whether the message has the same conference identifier as said previous message.

3. The method of claim 1, applied in a H323 network.

4. The method of claim 3, wherein the messages to be dispatched are “Registration, Admission and status” (RAS) messages.

5. The method of claim 4, further comprising identifying whether the message is a registration or an admission message, and, if the message is identified as a registration message, determining the sub-process to which the message is going to be dispatched on the basis of the current load of the different sub-processes in order to balance the load of the different sub-processes.

6. The method according to claim 4, comprising identifying whether the message is a registration or an admission message, and, if the message is an admission message, determining whether the message is the first admission message of a call, and, in that case, determining the sub-process to which the message is going to be dispatched on the basis of the current load of the different sub-processes in order to balance the load of the different sub-processes.

7. The method according to claim 1, wherein the messages to be dispatched enter the gatekeeper system in an encoded form and comprise several fields, one or several of these fields containing data which identify a call and further wherein the dispatching step includes decoding the message only partially, the decoded part including said one or several fields which contain those data.

8. The method according to claim 7, further comprising examining fields of the message in sequence until finding said one or several fields which contain the data which identify the call.

9. The method of claim 8, further comprising reading one or several fields of the message which indicate the type of the message and deducing, on the basis of the type of the message, a sequence of field types concerning the fields which are placed before said one or several fields that contain the call identifying data.

10. The method of claim 9, further comprising examining a field which indicates whether some optional fields are present or not before said one or several fields which contain the call identifying data, in order to determine whether such optional fields should be found or not when examining the fields in sequence.

11. A gatekeeper system of an Internet Protocol network, the gatekeeper system hosting a plurality of sub-processes each able to process a series of messages, wherein the gatekeeper system is adapted to dispatch the messages onto those different sub-processes, and further wherein the gatekeeper system has means for identifying whether a message belongs to a same call as a previous message, and, in that case, sending this message to the sub-process that processed the previous message.

12. The gatekeeper system of claim 11, further comprising means to identify whether a message has a same conference identifier as a previous message, and, in that case, sending this message to the sub-process that processed the previous message.

13. A component for a gatekeeper system of an Internet Protocol Network, comprising means for dispatching messages incoming on that component onto a plurality of sub-processes, the component being able to identify whether a message belongs to a same call as a previous message, and, in that case, being able to send this message to the sub-process that processed said previous message.

14. The component of claim 13, including means to identify whether a message has a same conference identifier as a previous message and, in that case, sending this message to the sub-process that processed said previous message.

15. A method for processing messages incoming on a gatekeeper system of an Internet Protocol network, wherein the gatekeeper system comprises a plurality of sub-processes each able to process a series of such messages, and further wherein the messages enter the gatekeeper system in an encoded form and comprise a plurality of fields, at least one of which contains data for identifying a call, the method including the step of dispatching the messages incoming on the gatekeeper system onto those different sub-processes, the dispatching step including identifying whether a message belongs to the same call as a previous message, and, in that case, sending the message to the same sub-process as the previous message, and further wherein the dispatching step includes decoding the message only partially, the decoded part including said one or several fields which contain those data.

16. A gatekeeper system operating in accordance with the method of claim 1.

17. A gatekeeper system operating in accordance with the method of claim 15.
